(19) United States
(12) Patent Application Publication
(10) Pub. No.: US 2019/0385241 A1
(43) Pub. Date: Dec. 19, 2019

(54) BILL PAYMENT MECHANISM FOR PAYROLL DEDUCTION

(71) Applicant: ADP, LLC, Roseland, NJ (US)

(72) Inventors: Kurt D. Newman, Columbus, GA (US); Debashis Ghosh, Charlotte, NC (US); Robert Wohlers, Castro Valley, CA (US)

(21) Appl. No.: 16/011,444

(22) Filed: Jun. 18, 2018

(51) Int. Cl. G06Q 40/00; G06Q 20/14

(52) U.S. Cl. CPC G06Q 40/125; G06Q 20/14

(57) ABSTRACT

A method, computer system, and computer program product pays a bill payment amount for an employee from a non-payroll account prior to a payroll payment date of the employee, and deducts on the payroll payment date of the employee from a payroll payment amount of the employee, the bill payment amount.

### BACKGROUND INFORMATION

### 1. Field

The present disclosure relates generally to an improved computer system and, in particular, to a method and apparatus for accessing information in a computer system. Still more particularly, the present disclosure relates to a method and apparatus for reducing risk in payment of debt obligations.

### 2. Background

The amount of debt obligations that an individual may have can increase dramatically after the individual enters a workforce. In the workforce, the individual receives a pay amount on a payday from which taxes and health obligations may be deducted. However, the individual may acquire a number of debt obligations. Some debt obligations, such as mortgage payments on a home and automobile loan payments, may require payments every month. Other debt obligations may require quarterly, semi-annual, or annual payments such as insurance, and additional taxes. While credit cards provided by credit card service companies offer convenience in paying some bills, the credit card service companies will require at least minimum payments based on the amounts owed to the credit card service companies.

The debt obligations discussed above, as well as others that may be incurred, provide for a number of penalties for late payments. Late payments may affect an individual's credit score. For a salaried individual, payments on debt obligations usually must come from the funds provided to the individual on payday. Therefore, risks are incurred in debt obligation payments since mistakes in planning for payment of the debt obligations and errors in timely payment of the debt obligations may result in loss of capital due to penalties and interest and other indirect losses due to lowering of the individual's credit score. Therefore, a need arises for a way to reduce the risk in the payment of the debt obligations.

Therefore, it would be desirable to have a method and apparatus that take into account at least some of the issues discussed above, as well as other possible issues. For example, it would be desirable to have a method and apparatus that overcome a technical problem of reducing risk in payment of debt obligations by a bill payment mechanism available to employees who receive a salary payment on a payment date.

### SUMMARY

An embodiment of the present disclosure provides a method for paying, by a bill pay application running on a processor unit, a bill payment amount for an employee from a non-payroll account prior to a payroll payment date of the employee; and for deducting, by a payroll application running on the processor unit, on the payroll payment date of the employee from a payroll payment amount of the employee, the bill payment amount.

Another embodiment of the present disclosure is a computer system for a data processing system connected to a network, a number of internal databases, and a number of external data sources, wherein the number of internal databases includes a number of payroll databases. A payroll application runs on a processor unit of the data processing system. A bill pay application runs on the processor unit of the data processing system. Computer program instructions for the bill pay application, stored in a computer-readable storage medium, are configured to cause the processor unit to pay a bill payment amount for an employee from a non-payroll account prior to a payroll payment date of the employee. The computer program instructions for the payroll application, stored in a computer-readable storage medium, are configured to cause the processor unit to deduct, from the payroll on the payment date of the employee from a payroll payment amount of the employee, the bill payment amount.

Yet another embodiment of the present disclosure provides a computer program product for reducing an amount of errors in bill payments. The computer program product comprises computer program instructions stored in a computer-readable storage medium and configured to cause the processor unit to pay a bill payment amount for an employee from a non-payroll account prior to a payroll payment date of the employee. The computer program product further comprises computer program instructions stored in the computer-readable storage medium and configured to cause the processor unit to deduct, from the payroll on the payment date of the employee from a payroll payment amount of the employee, the bill payment amount.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of an information environment in accordance with an illustrative embodiment;

FIG. 2 is a block diagram of a computer system for reducing risk in payment of debt obligations in accordance with an illustrative embodiment;

FIG. 3 is a database for access by a bill pay application in accordance with an illustrative embodiment;

FIG. 4 is an illustration of internal data accessed by a bill pay application in accordance with an illustrative embodiment;

FIG. 5 is an illustration of external data accessed by a bill pay application in accordance with an illustrative embodiment;

FIG. 6 is an illustration of a flowchart of a process for paying and deducting a bill pay amount in accordance with an illustrative embodiment;

FIG. 7 is an illustration of a flowchart of a process for preparation and delivery of a payroll statement in accordance with an illustrative embodiment;

FIG. 8 is an illustration of a flowchart of a process for opening a bill pay account by an employee in accordance with an illustrative embodiment;

FIG. 9 is an illustration of a flowchart of a process for receiving a bill pay amount and an authorization to pay a bill by an employer in accordance with an illustrative embodiment;

FIG. 10 is an illustration of a flowchart of a process for creating a bill pay schedule, an automatic payment, and a notification in accordance with an illustrative embodiment;

FIG. 11 is an illustration of a flowchart of a process for creating an escrow account in accordance with an illustrative embodiment;

FIG. 12 is an illustration of a flowchart of a process for paying a bill payment amount by an employer from an escrow account in accordance with an illustrative embodiment;

FIG. 13 is an illustration of a flowchart of a process for establishing a bill pay account service in accordance with an illustrative embodiment;

FIG. 14 is an illustration of a flowchart of a process for populating employee a bill pay services profile from internal sources in accordance with an illustrative embodiment;

FIG. 15 is an illustration of a flowchart of a process for populating employee bill pay services profile from external sources in accordance with an illustrative embodiment; and

FIG. 16 is an illustration of a block diagram of a data processing system in accordance with an illustrative embodiment.

### DETAILED DESCRIPTION

The illustrative embodiments recognize and take into account one or more different considerations. For example, the illustrative embodiments recognize and take into account that bill payment using payroll deduction may provide convenience for employees.

The illustrative embodiments further recognize and take into account that bill payment using payroll deduction may reduce risk associated with loan repayment.

The illustrative embodiments recognize and take into account that bill payment using payroll deduction may reduce attrition from employees. For example, financial institutions have created web sites to provide specific services to customers. The customers then do not want to leave the financial institution for another financial institution because they do not want to give up the service. In like manner, bill pay by an employer using payroll deduction may be offered by a web site and would be a service that an employee would not want to give up by moving to another employer. Therefore, offering such a service would be adding an additional factor for an employee to consider when contemplating making a job change.

The illustrative embodiments recognize and take into account that paying bills is a time-consuming and tedious process that has to be accomplished at potentially inconvenient times. Employees may pay bills late because of schedule challenges. For example, the employees may pay the bills late because of unexpected interruptions. Moreover, the employees may have difficulty managing finances to prepare for scheduled expenses such as automobile loan payments on a monthly basis, insurance payments on a quarterly or annual basis, and retirement savings on a number of different schedules.

The illustrative embodiments recognize and take into account that setting up bill payment as a payroll deduction may be provided with varying pay frequency and amounts.

The illustrative embodiments recognize and take into account that a process may be designed that will be compatible with ACH processes employed by utilities and credit card companies that pull data from deposit accounts. For example, utility and credit card companies send messages to customers informing them of an amount that will be withdrawn and a date the amount will be withdrawn.

The illustrative embodiments recognize and take into account that funds may be advanced by an employer from an employer account to pay one or more bills for an employee, and then those funds used to pay the one or more bills may be refunded to the employer by payroll deduction.

The illustrative embodiments recognize and take into account that payroll deductions may also be arranged using escrow accounts. For example, mortgage companies may provide for a payroll deduction of an amount each month until a full amount for payment of taxes and insurance is reached. The payment for taxes and insurance is then deducted from the escrow account and paid to a taxing authority and to the insurance company.

The illustrative embodiments recognize and take into account that payroll deductions may be projected based on observed bills so that an employee may receive an estimate of what pay they will receive after deductions for bill payments and after all bills are accounted for.

Thus, a method and apparatus that would allow for a mechanism to prevent errors in payment of debt obligations would fill a long-felt need in the field of reducing risk in payment of debt obligations.

Furthermore, the illustrative embodiments recognize and take into account that a method and apparatus that provides a centralized bill payment mechanism, available to an employee who receives a salary payment on a payment date, and that enabled payment, by an employer, of debt obligations of the employee in advance of the salary payment date would reduce errors in payment of the employee's debt obligations.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added, in addition to the illustrated blocks, in a flowchart or block diagram.

As used herein, the phrase “at least one of,” when used with a list of items, means different combinations of one or more of the listed items may be used and only one of each item in the list may be needed. In other words, “at least one of” means any combination of items and number of items may be used from the list, but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A, one of item B, and ten of item C; four of item B and seven of item C; or other suitable combinations.

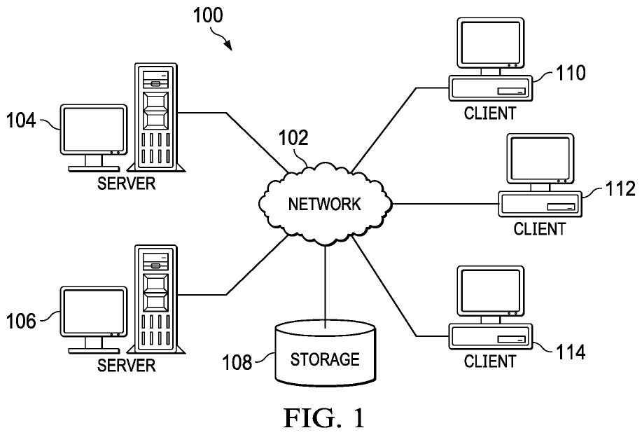

With reference now to the figures and, in particular, with reference to FIG. 1, an illustration of a diagram of a data processing environment is depicted in accordance with an illustrative embodiment. It should be appreciated that FIG. 1 is only provided as an illustration of one implementation and is not intended to imply any limitation with regard to the environments in which the different embodiments may be implemented. Many modifications to the depicted environments may be made.

The computer-readable program instructions may also be loaded onto a computer, a programmable data processing apparatus, or other device to cause a series of operational steps to be performed on the computer, a programmable apparatus, or other device to produce a computer-implemented process, such that the instructions which execute on the computer, the programmable apparatus, or the other device implement the functions and/or acts specified in the flowchart and/or block diagram block or blocks.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is a medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client computers include client computer 110, client computer 112, and client computer 114. Client computer 110, client computer 112, and client computer 114 connect to network 102. These connections can be wireless or wired connections depending on the implementation. Client computer 110, client computer 112, and client computer 114 may be, for example, personal computers or network computers. In the depicted example, server computer 104 provides information, such as boot files, operating system images, and applications to client computer 110, client computer 112, and client computer 114. Client computer 110, client computer 112, and client computer 114 are clients to server computer 104 in this example. Network data processing system 100 may include additional server computers, client computers, and other devices not shown.

Program code located in network data processing system 100 may be stored on a computer-recordable storage medium and downloaded to a data processing system or other device for use. For example, the program code may be stored on a computer-recordable storage medium on server computer 104 and downloaded to client computer 110 over network 102 for use on client computer 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation for the different illustrative embodiments.

The illustration of network data processing system 100 is not meant to limit the manner in which other illustrative embodiments can be implemented. For example, other client computers may be used in addition to or in place of client computer 110, client computer 112, and client computer 114 as depicted in FIG. 1. For example, client computer 110, client computer 112, and client computer 114 may include a tablet computer, a laptop computer, a bus with a vehicle computer, and other suitable types of clients.

In the illustrative examples, the hardware may take the form of a circuit system, an integrated circuit, an application-specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, programmable array logic, a field programmable logic array, a field programmable gate array, and other suitable hardware devices. Additionally, the processes may be implemented in organic components integrated with inorganic components and may be comprised entirely of organic components, excluding a human being. For example, the processes may be implemented as circuits in organic semiconductors.

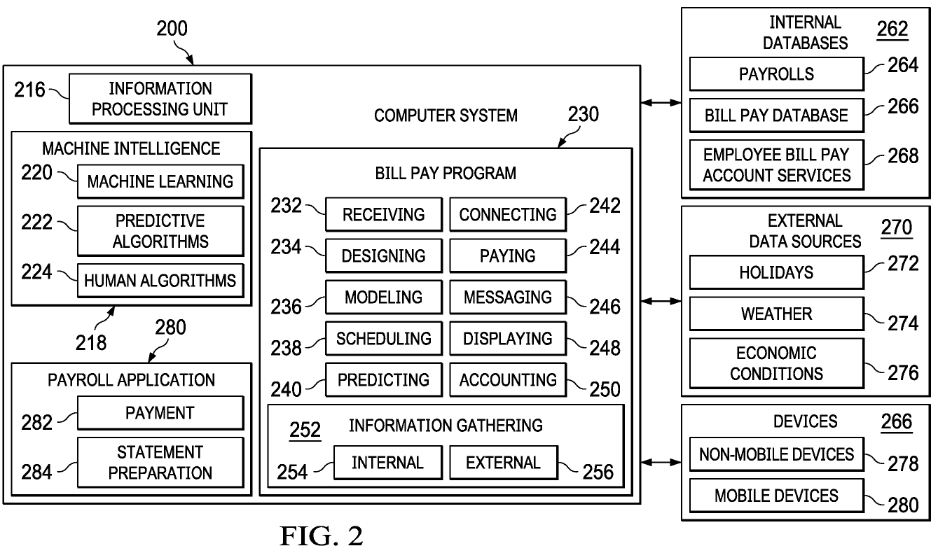

Turning to FIG. 2, a block diagram of a computer system for reducing risk in payment of debt obligations is depicted in accordance with an illustrative embodiment. Computer system 200 is connected to internal databases 262, external data sources 270, and devices 266. Internal databases 262 comprise payrolls 264, bill pay database 266, and employee bill pay account services 268. External data sources 270 may comprise, without limitation, holidays 272, weather 274, and economic conditions 276. Devices 266 comprise non-mobile devices 278 and mobile devices 280.

Computer system 200 comprises information processing unit 216, machine intelligence 218, bill pay program 230, and payroll application 280. Machine intelligence 218 comprises machine learning 220, predictive algorithms 222, and human algorithms 224. Machine intelligence 218 can be implemented using one or more systems such as an artificial intelligence system, a neural network, a Bayesian network, an expert system, a fuzzy logic system, a genetic algorithm, or other suitable types of systems. Machine learning 220, predictive algorithms 222, and human algorithms 224 may make computer system 200 a special purpose computer for projecting, based on observed bills, an estimate of what pay an employee will receive after deductions for bill payments and after all bills are accounted for, as well as other recommendations to the employee regarding scheduling of the bill payments.

Bill pay program 230 comprises receiving 232, designing 234, modeling 236, scheduling 238, predicting 240, connecting 242, paying 244, messaging 246, displaying 248, accounting 250, and information gathering 252. Information gathering 252 comprises internal 254 and external 256. Internal 254 is configured to gather data from internal databases 262. External 256 is configured to gather data from external data sources 270.

Computer system 200 may use one or more programs such as machine intelligence 218, bill pay program 230, and payroll application 280 to prevent errors in payment of debt obligations by providing for a centralized bill payment process available to employees who receive a salary payment on a payment date. As a result, computer system 200 operates as a special purpose computer system in which machine intelligence 218, bill pay program 230, and payroll application 280 enable payment, by an employer, of debt obligations of an employee in advance of a payroll payment date, thereby reducing errors in the payment of the debt obligations.

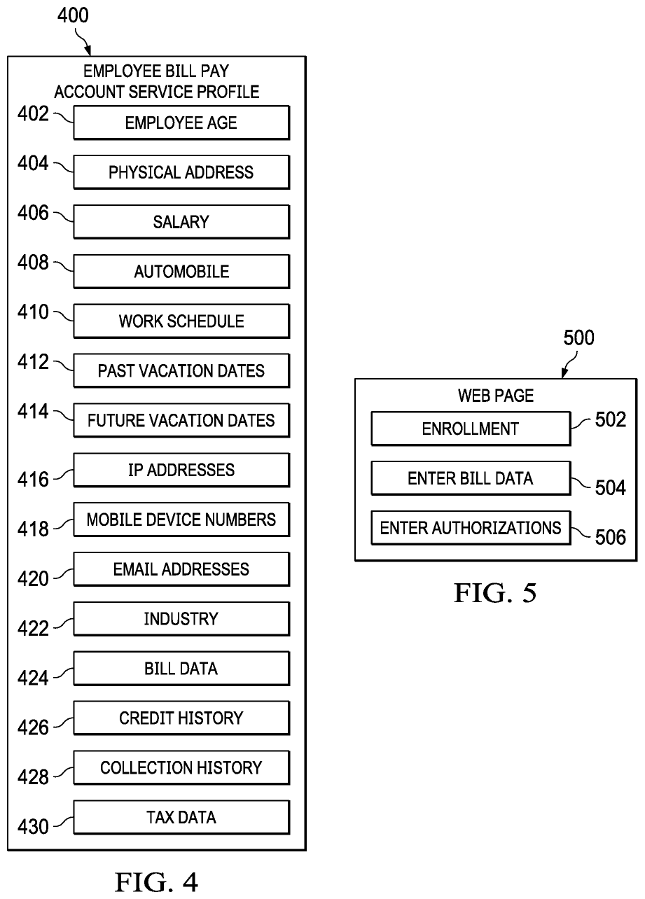

Computer system 200 may use bill pay program 230 in conjunction with machine intelligence 218 and employee bill pay account services profile 400 in FIG. 4 to provide recommendations to the employee regarding scheduling and payments of bills in the future.

Thus, bill pay program 230 transforms a computer system into a special purpose computer system as compared to currently available general computer systems that do not have a means to reduce errors in bill payments such as computer system 200 of FIG. 2, and as further described in FIGS. 5-14. Currently used general computer systems do not have a means to reduce errors in bill payments by providing a centralized bill payment mechanism, available to an employee who receives a salary payment on a payment date, and that enables payment, by an employer, of debt obligations of the employee in advance of the salary payment date as described in FIGS. 2-7.

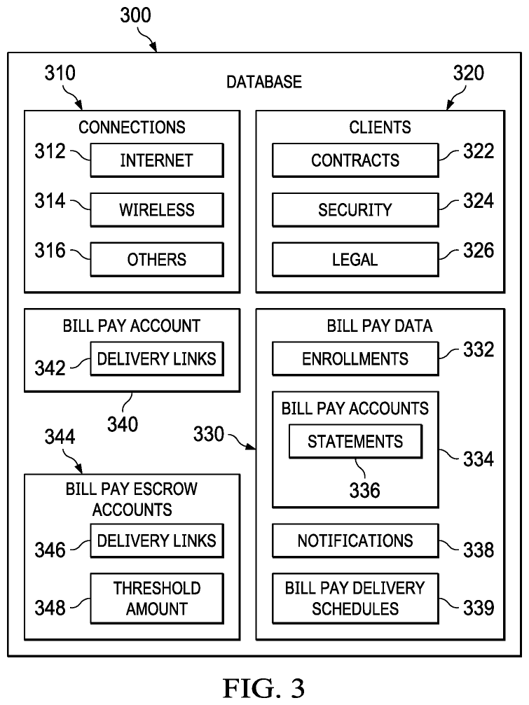

Turning to FIG. 3, a block diagram of a database is depicted in accordance with an illustrative embodiment. Database 300 comprises connections 310, clients 320, and bill pay data 330. Connections 310 comprise internet 312, wireless 314, and others 316. Connections 310 may provide connectivity with internal databases 262, external data sources 270, and devices 266 shown in FIG. 2. Internet 312 and wireless 314 as well as others 316 in connections 310 in FIG. 3 may connect with internal databases 262, external data sources 270, and devices 266, shown in FIG. 2, through a network such as network 102 in FIG. 1. Others 316 may comprise any additional available means of connection other than internet 312 and wireless 314 such as a hard wired connection or a landline.

Clients 320 may comprise contracts 322, security 324, and legal 326. Clients 320 may be configured for information regarding clients who contract with a payroll organization employing computer system 200 shown in FIG. 2. Information regarding contracts with each of clients 320 may be maintained in contracts 322. Information regarding security of data and messaging may be maintained in security 324. Other legal information regarding clients and the payroll organization employing computer system 200 may be maintained in legal 326. Machine intelligence 218 of FIG. 2 may access clients 320 in regard to contract compliance, security compliance, and legal compliance before sending messages via messaging 246 application.

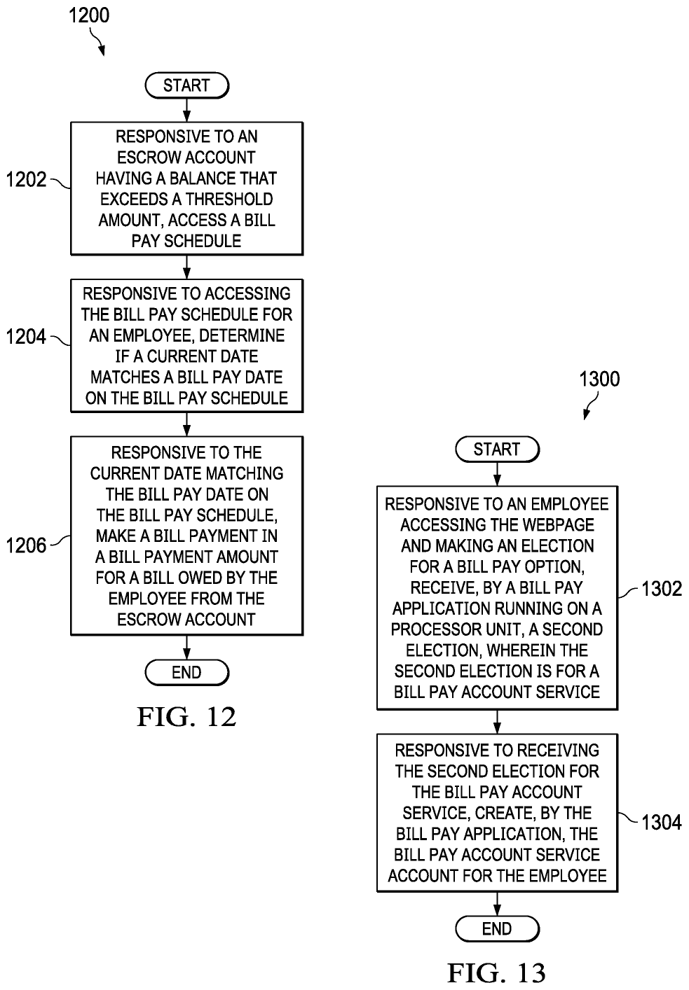

Bill pay data 330 may comprise enrollments 332, bill pay accounts 334, notifications 338, and bill pay delivery schedules 339. Bill pay accounts 334 may include statements 336. Enrollments 332 comprise employees who have elected a bill pay option. Bill pay accounts 334 comprise the bill pay accounts opened for those employees who have enrolled. Statements 336 may comprise a payroll data sheet showing all deductions and withholdings for the employee including a deduction for a bill payment. Notifications 338 comprise notifications to bill pay program 230 and payroll application 280 in FIG. 2 regarding an action to be taken in accordance with each enrollee's account. Bill pay account 340 may be one of bill pay accounts 334. Each bill pay account such as bill pay account 340 may have delivery links such as delivery links 342. Bill pay escrow accounts 344 may include delivery links 346 and threshold amount 348. Bill pay escrow accounts 344 may be established and used as depicted in FIG. 11 and in FIG. 12.

Turning to FIG. 4, an illustration of an employee bill pay account service profile that may be accessed by a bill pay application is depicted in accordance with an illustrative embodiment. Employee bill pay account service profile 400 may include, without limitation, employee age 402, physical address 404, salary 406, automobile 408, work schedule 410, past vacation dates 412, future vacation dates 414, internet protocol (IP) addresses 416, mobile device numbers 418, email addresses 420, industry 422, bill data 424, credit history 426, collection history 428, and tax data 430.

Turning to FIG. 5, an illustration of a web page displayed by a bill pay application is depicted in accordance with an illustrative embodiment. Web page 500 comprises enrollment 502, enter bill data 504, and enter authorizations 506. Web page 500 may be configured in any way in order to provide the functions of enrolling, entering bill data, and entering authorizations for payment of bills. Web page 500 provides a user interface for use by an employee to access the functionality of the bill pay application and the mechanism to reduce errors in bill payments and other features provided by computer system 200 in FIG. 2.

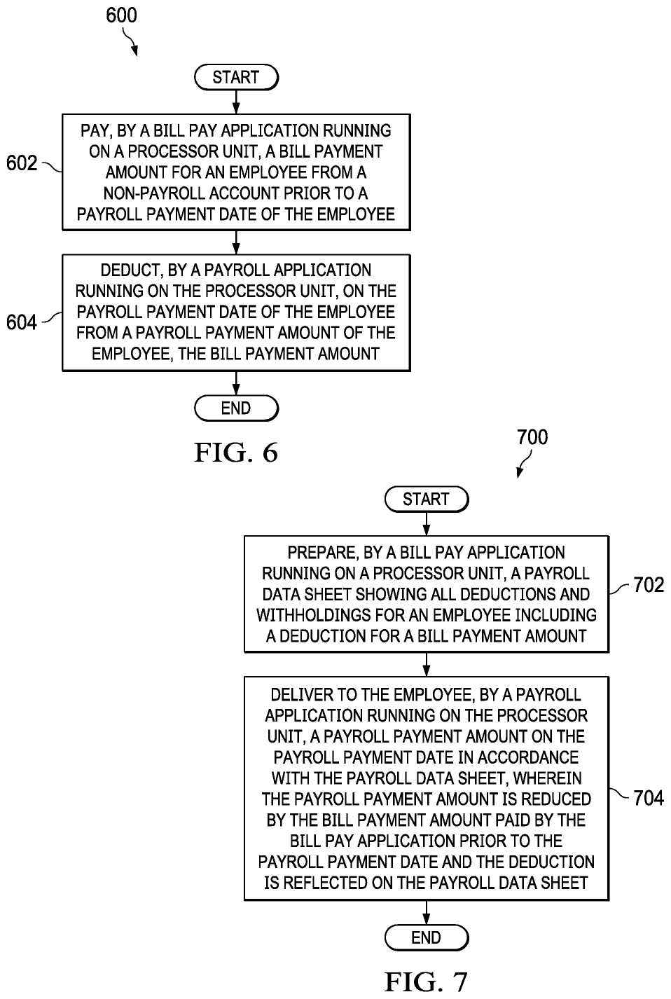

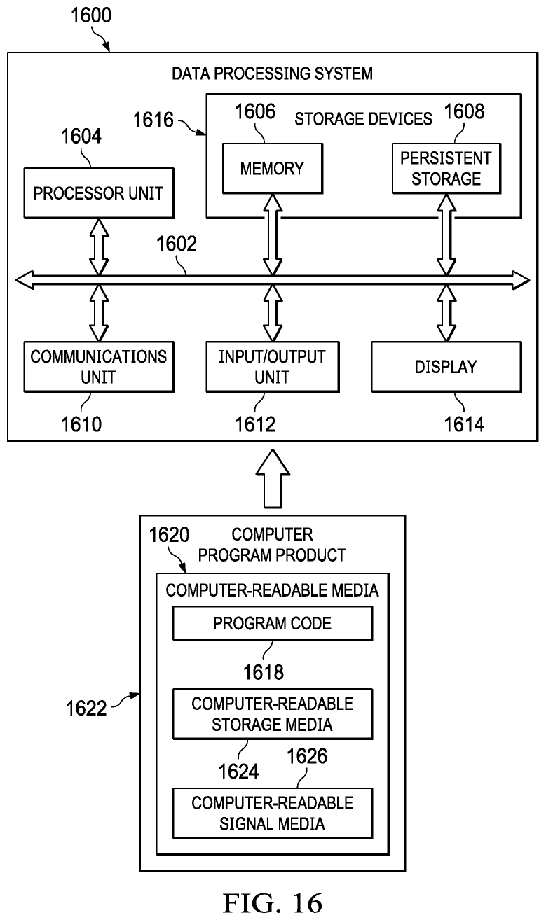

Turning to FIG. 6, an illustration of a flowchart of a process for paying and deducting a bill pay amount is depicted in accordance with an illustrative embodiment. Process 600 can be implemented in software, hardware, or a combination of the two. When software is used, the software comprises program code that can be loaded from a storage device and run by a processor unit in a computer system such as computer system 200 in FIG. 2. Computer system 200 may reside in a network data processing system such as network data processing system 100 in FIG. 1. For example, computer system 200 may reside on one or more of server computer 104, server computer 106, client computer 110, client computer 112, and client computer 114 connected by network 102 in FIG. 1. Moreover, process 600 can be implemented by data processing system 1600 in FIG. 16 and a processing unit such as processor unit 1604 in FIG. 16.

Process 600 starts. Process 600 pays, by a bill pay application running on a processor unit, a bill payment amount for an employee from a non-payroll account prior to a payroll payment date of the employee (step 602). The bill pay amount may be paid from an account such as bill pay account 340 by means of a delivery link from delivery links 342 in FIG. 3. The bill pay application may be bill pay program 230 in FIG. 2. Process 600, by a payroll application running on the processor unit, deducts the bill payment amount, on the payroll payment date of the employee from a payroll payment amount of the employee (step 604). The payroll application may be payroll application 280 in FIG. 2. The payroll may be from payrolls 264 in FIG. 2. Process 600 ends.

Turning to FIG. 7, an illustration of a flowchart of a process for preparation and delivery of a payroll statement is depicted in accordance with an illustrative embodiment. Process 700 can be implemented in software, hardware, or a combination of the two. When software is used, the software comprises program code that can be loaded from a storage device and run by a processor unit in a computer system such as computer system 200 in FIG. 2. Computer system 200 may reside in a network data processing system such as network data processing system 100 in FIG. 1. For example, computer system 200 may reside on one or more of server computer 104, server computer 106, client computer 110, client computer 112, and client computer 114 connected by network 102 in FIG. 1. Moreover, process 700 can be implemented by data processing system 1600 in FIG. 16 and a processing unit such as processor unit 1604 in FIG. 16.

Process 700 starts. Process 700 prepares, by a bill pay application running on a processor unit, a payroll data sheet showing all deductions and withholdings for an employee including a deduction for a bill payment amount (step 702). The bill pay application may be bill pay program 230 in FIG. 2. The payroll data sheet may be a statement prepared by accounting application 250. The statement may be further prepared by statement preparation 284 of payroll application 280. The statement may be one of statements 336 in bill pay accounts 334 in FIG. 3. Process 700 delivers to the employee, by a payroll application running on the processor unit, a payroll payment amount on a payroll payment date in accordance with the payroll data sheet, wherein the payroll payment amount is reduced by the bill payment amount paid by the bill pay application prior to the payroll payment date and the deduction is reflected on the payroll data sheet (step 704). Process 700 ends.

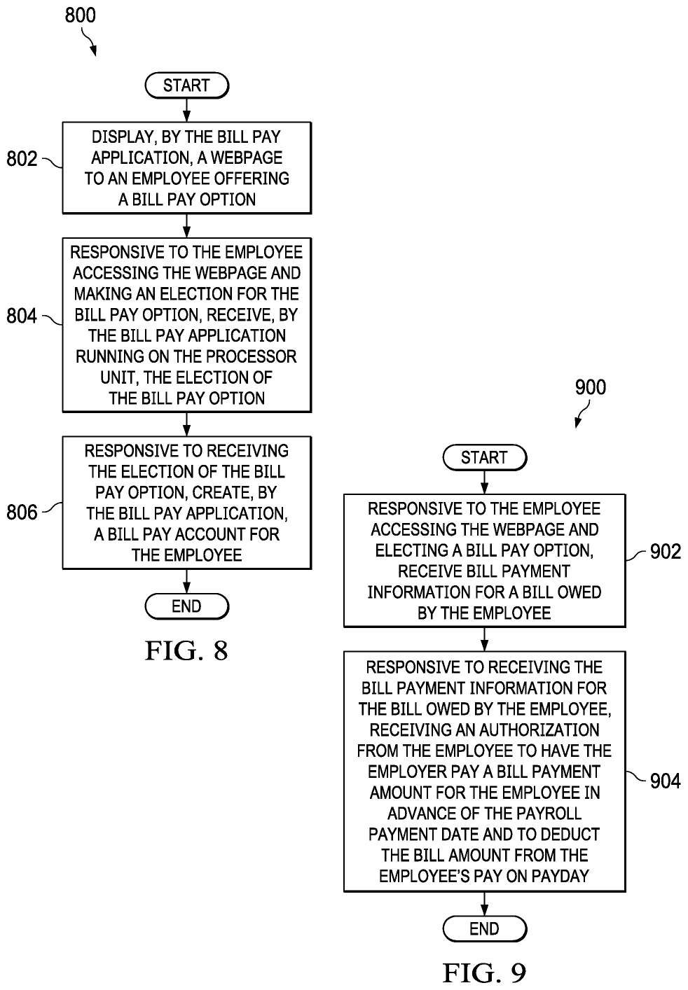

Turning to FIG. 8, an illustration of a flowchart of a process for opening a bill pay account by an employee is depicted in accordance with an illustrative embodiment. Process 800 can be implemented in software, hardware, or a combination of the two. When software is used, the software comprises program code that can be loaded from a storage device and run by a processor unit in a computer system such as computer system 200 in FIG. 2. Computer system 200 may reside in a network data processing system such as network data processing system 100 in FIG. 1. For example, computer system 200 may reside on one or more of server computer 104, server computer 106, client computer 110, client computer 112, and client computer 114 connected by network 102 in FIG. 1. Moreover, process 800 can be implemented by data processing system 1600 in FIG. 16 and a processing unit such as processor unit 1604 in FIG. 16.

Process 800 starts. Process 800 displays, by a bill pay application, a web page to an employee offering a bill pay option (step 802). The web page may be displayed on one or both of non-mobile devices 278 and mobile devices 280 by displaying 248 application of bill pay program 230 in FIG. 2. The web page may be a web page with selections such as web page 500 in FIG. 5. Process 800, responsive to the employee accessing the web page and making an election for the bill pay option, receives, by the bill pay application running on the processor unit, the election of the bill pay option (step 804.) Receiving the election of the bill pay option from a web page such as web page 500 in FIG. 5 may be made by receiving application 232 of bill pay program 230 in FIG. 2. Process 800, responsive to receiving the election of the bill pay option, creates, by the bill pay application, a bill pay account for the employee (step 806). The election of the bill pay option may be recorded in enrollments 332 of bill pay data 330 in FIG. 3. The bill pay account may be one of bill pay accounts 334 in FIG. 3. Process 800 ends.

Turning to FIG. 9, an illustration of a flowchart of a process for receiving a bill pay amount and an authorization to pay a bill by an employer is depicted in accordance with an illustrative embodiment. Process 900 can be implemented in software, hardware, or a combination of the two. When software is used, the software comprises program code that can be loaded from a storage device and run by a processor unit in a computer system such as computer system 200 in FIG. 2. Computer system 200 may reside in a network data processing system such as network data processing system 100 in FIG. 1. For example, computer system 200 may reside on one or more of server computer 104, server computer 106, client computer 110, client computer 112, and client computer 114 connected by network 102 in FIG. 1. Moreover, process 900 can be implemented by data processing system 1600 in FIG. 16 and a processing unit such as processor unit 1604 in FIG. 16.

Process 900 starts. Process 900, responsive to an employee accessing a web page and electing a bill pay option, receives bill payment information for a bill owed by the employee (step 902). The bill payment information may be bill pay data entered by enter bill data 504 on web page 500 in FIG. 5 and received by receiving 232 application of bill pay program 230 in FIG. 2. Process 900, responsive to receiving the bill payment information for the bill owed by the employee, receives an authorization from the employee to have an employer pay a bill payment amount for the employee in advance of a payroll payment date and to deduct the bill payment amount from the employee's pay on payday (step 904). The authorization may be entered using enter authorizations 506 of web page 500 and may be received by receiving 232 application of bill pay program 230 in FIG. 2. Process 900 ends.

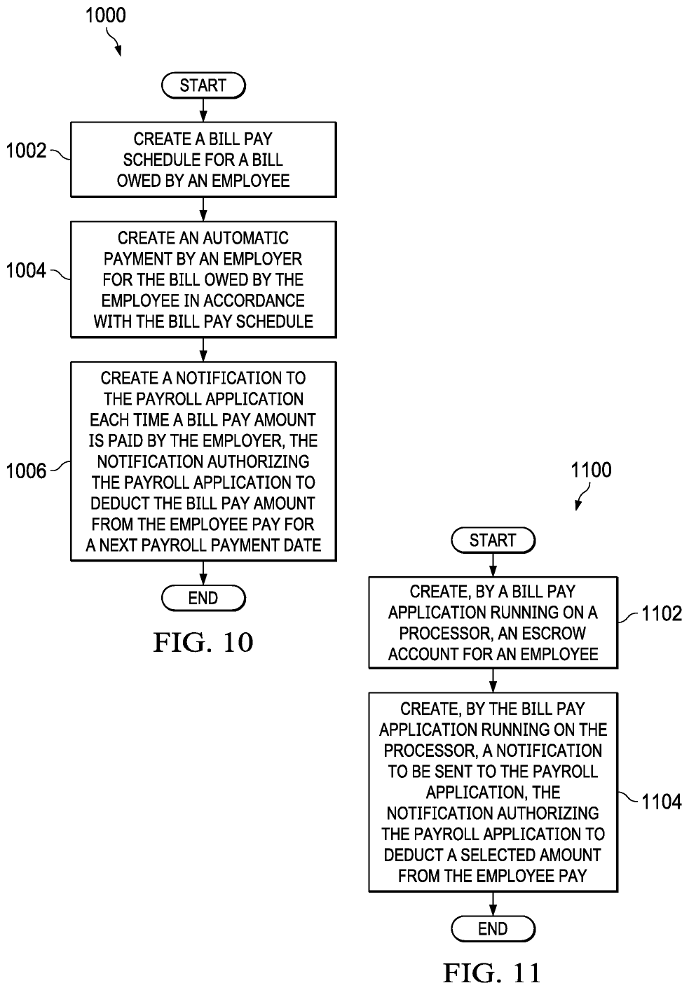

Turning to FIG. 10, an illustration of a flowchart of a process for creating a bill pay schedule, an automatic payment, and a notification is depicted in accordance with an illustrative embodiment. Process 1000 can be implemented in software, hardware, or a combination of the two. When software is used, the software comprises program code that can be loaded from a storage device and run by a processor unit in a computer system such as computer system 200 in FIG. 2. Computer system 200 may reside in a network data processing system such as network data processing system 100 in FIG. 1. For example, computer system 200 may reside on one or more of server computer 104, server computer 106, client computer 110, client computer 112, and client computer 114 connected by network 102 in FIG. 1. Moreover, process 1000 can be implemented by data processing system 1600 in FIG. 16 and a processing unit such as processor unit 1604 in FIG. 16.

Process 1000 starts. Process 1000 creates a bill pay schedule for a bill owed by an employee (step 1002). The bill pay schedule may be one of bill pay delivery schedules 339 in FIG. 3. The bill pay delivery schedule may be prepared by scheduling 238 application of bill pay program 230 in FIG. 2. Process 1000 creates an automatic payment by an employer for the bill owed by the employee in accordance with the bill pay delivery schedule (step 1004). The automatic payment may be made by paying 244 application of bill pay program 230 in FIG. 2. The automatic payment may be in accordance with bill pay delivery schedules 339 by using connections 310 and delivery links 342 in FIG. 3 by bill pay program 230 in FIG. 2. Process 1000 creates a notification to the payroll application each time a bill pay amount is paid by the employer, the notification authorizing the payroll application to deduct the bill pay amount from employee pay for a next payroll payment date. The notification may be one of notifications 338 in FIG. 3 and may be sent by messaging 246 application of bill pay program 230 in FIG. 2 (step 1006). Process 1000 ends.

Turning to FIG. 11, an illustration of a flowchart of a process for creating an escrow account is depicted in accordance with an illustrative embodiment. Process 1100 can be implemented in software, hardware, or a combination of the two. When software is used, the software comprises program code that can be loaded from a storage device and run by a processor unit in a computer system such as computer system 200 in FIG. 2. Computer system 200 may reside in a network data processing system such as network data processing system 100 in FIG. 1. For example, computer system 200 may reside on one or more of server computer 104, server computer 106, client computer 110, client computer 112, and client computer 114 connected by network 102 in FIG. 1. Moreover, process 1100 can be implemented by data processing system 1600 in FIG. 16 and a processing unit such as processor unit 1604 in FIG. 16.

Process 1100 starts. Process 1100 creates, by a bill pay application running on a processor, an escrow account for an employee (step 1102). The escrow account may be bill pay escrow account 344 in FIG. 3 and be created by accounting 250 application of bill pay program 230 in FIG. 2. Process 1100 creates, by the bill pay application running on the processor, a notification to be sent to a payroll application, the notification authorizing the payroll application to deduct a selected amount from the employee's pay (step 1104). The notification may be one of notifications 338 in FIG. 3 and may be sent by messaging 246 application of bill pay program 230 in FIG. 2. Process 1100 ends.

Turning to FIG. 12, an illustration of a flowchart of a process for paying a bill payment amount by an employer from an escrow account is depicted in accordance with an illustrative embodiment. Process 1200 can be implemented in software, hardware, or a combination of the two. When software is used, the software comprises program code that can be loaded from a storage device and run by a processor unit in a computer system such as computer system 200 in FIG. 2. Computer system 200 may reside in a network data processing system such as network data processing system 100 in FIG. 1. For example, computer system 200 may reside on one or more of server computer 104, server computer 106, client computer 110, client computer 112, and client computer 114 connected by network 102 in FIG. 1. Moreover, process 1200 can be implemented by data processing system 1600 in FIG. 16 and a processing unit such as processor unit 1604 in FIG. 16.

Process 1200 starts. Process 1200, responsive to an escrow account having a balance that exceeds a threshold amount, accesses a bill pay schedule (step 1202). The escrow account may be an account from bill pay escrow accounts 344. The threshold amount may be threshold amount 348 in FIG. 3. A calculation that the balance exceeds the threshold amount may be made by accounting 250 application in bill pay program 230 in FIG. 2. Process 1200, responsive to accessing the bill pay schedule for an employee, determines if a current date matches a bill pay date on the bill pay schedule (step 1204). The bill pay schedule may be one of bill pay delivery schedules 339 in FIG. 3. The determination of whether the current date matches the bill pay date may be made by scheduling 238 application in bill pay program 230 in FIG. 2. Process 1200, responsive to the current date matching the bill pay date on the bill pay schedule, makes a bill payment in a bill payment amount for a bill owed by the employee from the escrow account (step 1206). The escrow account may be one of bill pay escrow accounts 344. The bill payment may be made by using paying 244 application of bill pay program 230 in FIG. 2 by using one of delivery links 346 in FIG. 3. Process 1200 ends.

Turning to FIG. 13, an illustration of a flowchart of a process for establishing a bill pay account service is depicted in accordance with an illustrative embodiment. Process 1300 can be implemented in software, hardware, or a combination of the two. When software is used, the software comprises program code that can be loaded from a storage device and run by a processor unit in a computer system such as computer system 200 in FIG. 2. Computer system 200 may reside in a network data processing system such as network data processing system 100 in FIG. 1. For example, computer system 200 may reside on one or more of server computer 104, server computer 106, client computer 110, client computer 112, and client computer 114 connected by network 102 in FIG. 1. Moreover, process 1300 can be implemented by data processing system 1600 in FIG. 16 and a processing unit such as processor unit 1604 in FIG. 16.

Process 1300 starts. Process 1300, responsive to an employee accessing a web page and making an election for a bill pay option, receives, by a bill pay application running on a processor unit, a second election, wherein the second election is for a bill pay account service (step 1302). The second election may be made by using enrollment 502, enter bill data 504, and enter authorizations 506 of web page 500 in FIG. 5. The bill pay account service may be one of employee bill pay account services 268 in FIG. 2. Process 1300, responsive to receiving the second election for the bill pay account service, creates, by the bill pay application, a bill pay account service for the employee (step 1304). The bill pay account service may be one of employee bill pay account services 268 in FIG. 2. Process 1300 ends.

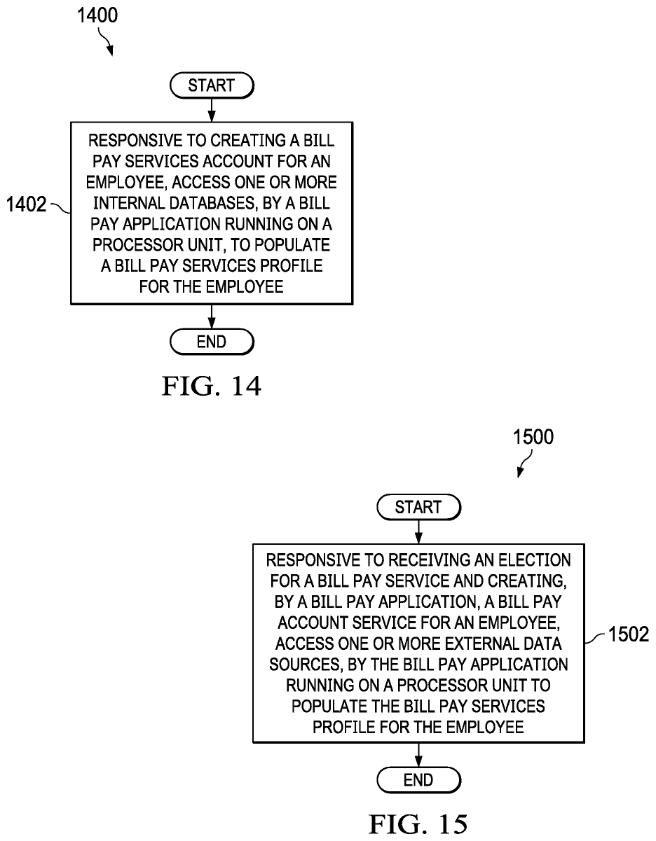

Turning to FIG. 14, an illustration of a flowchart of a process for populating an employee bill pay services profile from internal sources is depicted in accordance with an illustrative embodiment. Process 1400 can be implemented in software, hardware, or a combination of the two. When software is used, the software comprises program code that can be loaded from a storage device and run by a processor unit in a computer system such as computer system 200 in FIG. 2. Computer system 200 may reside in a network data processing system such as network data processing system 100 in FIG. 1. For example, computer system 200 may reside on one or more of server computer 104, server computer 106, client computer 110, client computer 112, and client computer 114 connected by network 102 in FIG. 1. Moreover, process 1400 can be implemented by data processing system 1600 in FIG. 16 and a processing unit such as processor unit 1604 in FIG. 16.

Process 1400 starts. Process 1400, responsive to creating a bill pay account service for an employee, accessing one or more internal databases, by a bill pay application running on a processor unit, to populate an employee bill pay services profile for the employee (step 1402). The bill pay services profile may be employee bill pay account service profile 400 in FIG. 4. Employee bill pay account service profile 400 may be used by predicting 240 application of bill pay program 230 and machine intelligence 218 in FIG. 2 to provide recommendations to the employee regarding scheduling and payments of bills in the future. Process 1400 ends.

Turning to FIG. 15, an illustration of a flowchart of a process for populating an employee bill pay services profile from external sources is depicted in accordance with an illustrative embodiment. Process 1500 can be implemented in software, hardware, or a combination of the two. When software is used, the software comprises program code that can be loaded from a storage device and run by a processor unit in a computer system such as computer system 200 in FIG. 2. Computer system 200 may reside in a network data processing system such as network data processing system 100 in FIG. 1. For example, computer system 200 may reside on one or more of server computer 104, server computer 106, client computer 110, client computer 112, and client computer 114 connected by network 102 in FIG. 1. Moreover, process 1500 can be implemented by data processing system 1600 in FIG. 16 and a processing unit such as processor unit 1604 in FIG. 16.

Process 1500 starts. Process 1500, responsive to receiving an election for a bill pay service and creating, by a bill pay application, a bill pay service account for an employee, accesses one or more external data sources, by the bill pay application running on a processor unit, to populate a bill payment service profile for the employee (step 1502). The election may be the second election in step 1304 in FIG. 13. The external data sources may be external data sources 270 in FIG. 2. For example, holidays 272, weather 274, and economic conditions 276 may be used by machine intelligence 218 and predicting 240 application of bill pay program 230 to provide recommendations to the employee regarding scheduling and payments of bills in the future. Process 1500 ends.

Turning now to FIG. 16, an illustration of a block diagram of a data processing system is depicted in accordance with an illustrative embodiment. Data processing system 1600 may be used to implement one or more computers and client computer system 112 in FIG. 1. In this illustrative example, data processing system 1600 includes communications framework 1602, which provides communications between processor unit 1604, memory 1606, persistent storage 1608, communications unit 1610, input/output unit 1612, and display 1614. In this example, communications framework 1602 may take the form of a bus system.

Processor unit 1604 serves to execute instructions for software that may be loaded into memory 1606. Processor unit 1604 may be a number of processors, a multi-processor core, or some other type of processor, depending on the particular implementation. Memory 1606 and persistent storage 1608 are examples of storage devices 1616. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1616 may also be referred to as computer-readable storage devices in these illustrative examples. Memory 1616, in these examples, may be, for example, a random access memory or any other suitable volatile or non-volatile storage device. Persistent storage 1608 may take various forms, depending on the particular implementation.

For example, persistent storage 1608 may contain one or more components or devices. For example, persistent storage 1608 may be a hard drive, a flash memory, a rewritable optical disk, a rewritable magnetic tape, or some combination of the above. The media used by persistent storage 1608 also may be removable. For example, a removable hard drive may be used for persistent storage 1608. Communications unit 1610, in these illustrative examples, provides for communications with other data processing systems or devices. In these illustrative examples, communications unit 1610 is a network interface card.

Input/output unit 1612 allows for input and output of data with other devices that may be connected to data processing system 1600. For example, input/output unit 1612 may provide a connection for user input through at least one of a keyboard, a mouse, or some other suitable input device. Further, input/output unit 1612 may send output to a printer. Display 1614 provides a mechanism to display information to a user.

Instructions for at least one of the operating system, applications, or programs may be located in storage devices 1616, which are in communication with processor unit 1604 through communications framework 1602. The processes of the different embodiments may be performed by processor unit 1604 using computer-implemented instructions, which may be located in a memory, such as memory 1606.

These instructions are referred to as program code, computer-usable program code, or computer-readable program code that may be read and executed by a processor in processor unit 1604. The program code in the different embodiments may be embodied on different physical or computer-readable storage media, such as memory 1606 or persistent storage 1608.

Program code 1618 is located in a functional form on computer-readable media 1620 that is selectively removable and may be loaded onto or transferred to data processing system 1600 for execution by processor unit 1604. Program code 1618 and computer-readable media 1620 form computer program product 1622 in these illustrative examples. In one example, computer-readable media 1620 may be computer-readable storage media 1624 or computer-readable signal media 1626.

In these illustrative examples, computer-readable storage media 1624 is a physical or tangible storage device used to store program code 1618 rather than a medium that propagates or transmits program code 1618. Alternatively, program code 1618 may be transferred to data processing system 1600 using computer-readable signal media 1626.

Computer-readable signal media 1626 may be, for example, a propagated data signal containing program code 1618. For example, computer-readable signal media 1626 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1600 are not meant to provide architectural limitations to the manner in which different embodiments may be implemented. The different illustrative embodiments may be implemented in a data processing system including components in addition to or in place of those illustrated for data processing system 1600. Other components shown in FIG. 16 can be varied from the illustrative examples shown. The different embodiments may be implemented using any hardware device or system capable of running program code 1618.

In an illustrative embodiment, a computer system for a data processing system is connected to a network, a number of internal databases, and a number of external data sources. The number of internal databases includes a number of payroll databases. A payroll application runs on a processor unit of the data processing system. A bill pay application runs on the processor unit of the data processing system. Computer program instructions for the bill pay application, stored in a computer-readable storage medium, are configured to cause the processor unit to pay a bill payment amount for an employee from a non-payroll account prior to a payroll payment date of the employee. The computer program instructions for the payroll application, stored in the computer-readable storage medium, are configured to cause the processor unit to deduct, on the payroll payment date of the employee, from a payroll payment amount of the employee, the bill payment amount.

Thus, in one illustrative embodiment, one or more technical solutions are present that overcome a technical problem in the area of reducing errors in bill payments. Errors in bill payments are reduced by providing a centralized bill payment mechanism, available to an employee who receives a salary payment on a payment date, and that enables payment, by an employer, of debt obligations of the employee in advance of the salary payment date. The technical solution provides for linking a payroll application with an employer bill pay account. The technical solution provides for a web page interface for the employee to sign up for automatic bill pay by the employer or to use an escrow account to save up for bill payment. The technical solution provides for a link between the web page, the bill pay services, and the payroll account. The technical solution provides for a link to accounting to add reimbursement to the employer, for paying the employee bill, to the employee's payroll statement and deduction from the employee's salary payment.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implemented method for reducing an amount of errors in bill payments, the computer-implemented method comprising:
paying, by a bill pay application running on a processor unit, a bill payment amount for an employee from a non-payroll account prior to a payroll payment date of the employee; and
deducting, by a payroll application running on the processor unit, on the payroll payment date of the employee from a payroll payment amount of the employee, the bill payment amount.

2. The computer-implemented method of claim 1, further comprising:
preparing, by the bill pay application running on the processor unit, a payroll data sheet showing all deductions and withholdings for the employee including a deduction for the bill payment amount; and
delivering to the employee, by the payroll application running on the processor unit, the payroll payment amount on the payroll payment date in accordance with the payroll data sheet, wherein the payroll payment amount is reduced by the bill payment amount paid by the bill pay application prior to the payroll payment date and the deduction is reflected on the payroll data sheet.

3. The computer-implemented method of claim 1, further comprising:
displaying, by the bill pay application, a web page to the employee offering a bill pay option;
responsive to the employee accessing the web page and making an election for the bill pay option, receiving, by the bill pay application running on the processor unit, the election of the bill pay option; and
responsive to receiving the election of the bill pay option, creating, by the bill pay application, a bill pay account for the employee.

4. The computer-implemented method of claim 3, further comprising:
responsive to the employee accessing the web page and electing the bill pay option, receiving bill payment information for a bill owed by the employee; and
responsive to receiving the bill payment information for the bill owed by the employee, receiving an authorization from the employee to have an employer pay the bill payment amount for the employee in advance of the payroll payment date and to deduct the bill payment amount from an employee's pay on a payday.

5. The computer-implemented method of claim 3, wherein creating the bill pay account for the employee further comprises:
creating a bill pay schedule for a bill owed by the employee;
creating an automatic payment by an employer for the bill owed by the employee in accordance with the bill pay schedule; and
creating a notification to the payroll application each time the bill pay amount is paid by the employer, the notification authorizing the payroll application to deduct the bill pay amount from an employee's pay for a next payroll payment date.

6. The computer-implemented method of claim 3, wherein creating the bill pay account for the employee further comprises:
creating, by the bill pay application running on the processor unit, an escrow account for the employee; and
creating, by the bill pay application running on the processor, a notification to be sent to the payroll application, the notification authorizing the payroll application to deduct a selected amount from an employee's pay.

7. The computer-implemented method of claim 6, further comprising:
responsive to the escrow account having a balance that exceeds a threshold amount, accessing a bill pay schedule;
responsive to accessing the bill pay schedule for the employee, determining if a current date matches a bill pay date on the bill pay schedule; and
responsive to the current date matching the bill pay date on the bill pay schedule, making a bill payment in the bill payment amount for a bill owed by the employee from the escrow account.

8. The computer-implemented method of claim 3, further comprising:
responsive to the employee accessing the web page and making the election for the bill pay option, receiving, by the bill pay application running on the processor unit, a second election, wherein the second election is for a bill pay service; and
responsive to receiving the second election for the bill pay service, creating, by the bill pay application, a bill pay account service for the employee.

9. The computer-implemented method of claim 8, further comprising:
responsive to creating the bill pay account service for the employee, accessing one or more internal databases, by the bill pay application running on the processor unit, to populate an employee bill pay services profile for the employee.

10. The computer-implemented method of claim 8, wherein the one or more internal databases comprise one or more of an age of the employee, a physical address of the employee, a salary of the employee, an automobile of the employee, a work schedule of the employee, past vacation dates, future vacation dates, IP addresses of the employee, mobile device numbers of the employee, email addresses of the employee, an industry of the employee, and a geographic location of the employee.

11. The computer-implemented method of claim 8, further comprising:
responsive to receiving the second election for the bill pay service and creating, by the bill pay application, the bill pay account service for the employee, accessing one or more external data sources, by the bill pay application running on the processor unit, to populate an employee bill payment services profile for the employee.

12. The computer-implemented method of claim 11, wherein the external data sources comprise one or more of holidays, weather, and economic conditions.

13. A system for reducing an amount of errors in bill payments, the system comprising:
a data processing system connected to a network, a number of internal databases, and a number of external data sources, wherein the number of internal databases includes a number of payroll databases;
a payroll application running on a processor unit of the data processing system;
a bill pay application running on the processor unit of the data processing system;
computer program instructions for the bill pay application, stored in a computer-readable storage medium and configured to cause the processor unit to pay a bill payment amount for an employee from a non-payroll account prior to a payroll payment date of the employee; and
computer program instructions for the payroll application, stored in the computer-readable storage medium and configured to cause the processor unit to deduct from a payroll on the payroll payment date of the employee from a payroll payment amount of the employee, the bill payment amount.

14. The system of claim 13, further comprising:
computer program instructions for the payroll application, stored in the computer-readable storage medium and configured to cause the processor unit to prepare a payroll data sheet showing all deductions and withholdings for the employee including a deduction for the bill payment amount; and
computer program instructions for the payroll application, stored in the computer-readable storage medium and configured to cause the processor unit to deliver to the employee the payroll payment amount on the payroll payment date in accordance with the payroll data sheet, wherein the payroll payment amount is reduced by the bill payment amount paid by the bill pay application prior to the payroll payment date and the deduction is reflected on the payroll data sheet.

15. The system of claim 13, further comprising:
computer program instructions for the bill pay application, stored in the computer-readable storage medium and configured to cause the processor unit to display a web page to the employee offering a bill pay option;
computer program instructions for the bill pay application, stored in the computer-readable storage medium and configured to cause the processor unit, responsive to the employee accessing the web page and making an election for the bill pay option, to receive the election of the bill pay option; and
computer program instructions for the bill pay application, stored in the computer-readable storage medium and configured to cause the processor unit, responsive to receiving the election of the bill pay option, to create a bill pay account for the employee.

16. The system of claim 13, further comprising:
computer program instructions for the bill pay application, stored in the computer-readable storage medium and configured to cause the processor unit to create an escrow account for the employee; and
computer program instructions for the bill pay application, stored in the computer-readable storage medium and configured to cause the processor unit to create a notification to be sent to the payroll application, the notification authorizing the payroll application to deduct a selected amount from an employee's pay.

17. The system of claim 16, further comprising:
computer program instructions for the bill pay application, stored in the computer-readable storage medium and configured to cause the processor unit, responsive to the escrow account having a balance that exceeds a threshold amount, to access a bill pay schedule;
computer program instructions for the bill pay application, stored in the computer-readable storage medium and configured to cause the processor unit, responsive to accessing the bill pay schedule for the employee, to determine if a current date matches a bill pay date on the bill pay schedule; and
computer program instructions for the bill pay application, stored in the computer-readable storage medium and configured to cause the processor unit, responsive to the current date matching the bill pay date on the bill pay schedule, to make a bill payment in the bill payment amount for a bill owed by the employee from the escrow account.

18. The system of claim 13, further comprising:
computer program instructions for the bill pay application, stored in the computer-readable storage medium and configured to cause the processor unit, responsive to the employee accessing a web page and making an election for a bill pay option, to receiving a second election, wherein the second election is for a bill pay account service; and
computer program instructions for the bill pay application, stored in the computer-readable storage medium and configured to cause the processor unit, responsive to receiving the second election for the bill pay account service, to create the bill pay account service for the employee.

19. A computer program product for reducing an amount of errors in bill payments, the computer program product comprising:
computer program instructions stored in a computer-readable storage medium and configured to cause a processor unit to pay a bill payment amount for an employee from a non-payroll account prior to a payroll payment date of the employee; and
computer program instructions stored in the computer-readable storage medium and configured to cause the processor unit to deduct the payroll payment date of the employee from a payroll payment amount of the employee, the bill payment amount.

20. The computer program product of claim 19, further comprising:
computer program instructions stored in the computer-readable storage medium and configured to cause the processor unit to prepare a payroll data sheet showing all deductions and withholdings for the employee including a deduction for the bill payment amount; and
computer program instructions stored in the computer-readable storage medium and configured to cause the processor unit to deliver to the employee the payroll payment amount on the payroll payment date in accordance with the payroll data sheet, wherein the payroll payment amount is reduced by the bill payment amount paid by a bill pay application prior to the payroll payment date and the deduction is reflected on the payroll data sheet.
